(19) United States
(12) Patent Application Publication
(10) Pub. No.: US 2026/0241326 A1
(43) Pub. Date: Aug. 20, 2026

(54) Built Environment Air Processing Systems and Methods

(71) Applicant: CARBONQUEST, INC., Spokane Valley, WA (US)

(72) Inventors: Shane Johnson, Rosalia, WA (US); William A. Fuglevand, Spokane Valley, WA (US)

(73) Assignee: CARBONQUEST, INC., Spokane Valley, WA (US)

(21) Appl. No.: 19/480,664

(22) PCT Filed: May 3, 2024
(86) PCT No.: PCT/US2024/027659

§ 371 Date: Oct. 31, 2025

Related U.S. Application Data
(60) Provisional application No. 63/463,838, filed on May 3, 2023.

(51) Int. Cl. B01D 53/047; F24F 8/10; F24F 8/95; F25J 3/06

(52) U.S. Cl. CPC B01D 53/0476; F24F 8/10; F24F 8/95; F25J 3/067; B01D 2257/504; B01D 2258/06; F25J 2260/00

(57) ABSTRACT

A carbon capture system operatively associated with a built environment is provided. The system can include a direct air carbon dioxide capture component operatively engaged with a mechanical component of a built environment. A carbon capture system operatively associated with a built environment is also provided. The system can include a direct air carbon dioxide capture component operatively engaged with a combustion carbon capture system of the built environment. A method for capturing carbon dioxide associated with a built environment is provided. The method can include engaging a direct air carbon dioxide capture component with a mechanical component of the built environment to produce both a stream of reduced carbon dioxide air and a stream of carbon dioxide.

### CROSS REFERENCE TO RELATED APPLICATION

This application claims priority to and the benefit of U.S. Provisional Patent Application Ser. No. 63/463,838 filed May 3, 2023, entitled “Building Air Processing Systems and Methods”, the entirety of which is incorporated by reference herein.

### TECHNICAL FIELD

The field of the invention relates to the processing of air about and/or associated with a built environment. Example systems and/or methods can be utilized to process building air from within and/or about the building that can include carbon dioxide management systems and methods, and more particularly, be utilized by multi-story or large footprint buildings that utilize large combustion energy sources for building systems such as steam heating and hot water with byproduct generation of emissions. Other built environments can include stand alone facilities that generate carbon dioxide.

### BACKGROUND

Carbon dioxide is produced in many built environments. The environments can range from large industrial facilities to small stand alone fixed facilities such as remote stand alone compressors. As one example, carbon dioxide generation in buildings, particularly in large metropolitan areas, is a significant contributor to carbon dioxide generation overall. Carbon dioxide is currently listed as a global warming compound whose reduction is sought worldwide. The generation of carbon dioxide is a necessary part of respiration, which is a necessary part of life, but it is important to limit the generation of carbon dioxide in an effort to address climate change.

Additionally, it has become more important to regulate the living atmosphere within buildings to enhance the living environment. Accordingly, it i has become increasingly evident that high concentrations of carbon dioxide and other gas buildup within living spaces have typically been referred to as what is called “stagnant air”. This stagnant air can be troublesome, as it increases the health risk to inhabitants.

The present disclosure provides built environment air processing and systems that can address carbon dioxide generation and/or accumulation within the building, carbon dioxide capture from air about the building as well as carbon dioxide generation from combustion of fossil fuels and proliferation thereof in metropolitan areas. The present disclosure provides methods for enhancing the livable air with buildings utilizing implementations provided herein.

### SUMMARY

A built environment carbon capture system operatively associated with a built environment is provided, the system comprising a direct air carbon dioxide capture component operatively engaged with mechanical component of the built environment.

A carbon capture system operatively associated with a built environment is provided. The system can include a direct air carbon dioxide capture component operatively engaged with a carbon capture system of the built environment.

A method for capturing carbon dioxide associated with a built environment is provided. The method can include engaging a direct air carbon dioxide capture component with a mechanical component of the built environment to produce both a stream of reduced carbon dioxide air and a stream of carbon dioxide.

### BRIEF DESCRIPTION OF DRAWINGS

Embodiments of the disclosure are described below with reference to the following accompanying drawings.

FIG. 1 is a depiction of a direct air capture module associated with a built environment according to an embodiment of the disclosure.

FIG. 2 is a depiction of a more detailed view of one implementation of a direct air capture module according to another embodiment of the disclosure.

FIG. 3 is a depiction of a direct air capture module in combination with an HVAC system of a built environment according to an embodiment of the disclosure.

FIG. 4 is a more detailed depiction of an integration of an HVAC system with individual components of a direct air capture module.

FIG. 5 is a depiction of a direct air capture module in combination with a carbon capture component (Carbon Capture Utilization System, CCUS) according to an embodiment of the disclosure.

FIG. 6 is a depiction of a carbon capture system according to an embodiment of the disclosure.

FIG. 7 is a more detailed depiction of a portion of a carbon capture system according to an embodiment of the disclosure.

FIG. 8 is a depiction of a direct air capture module integrated with an HVAC system and a carbon capture component within a built environment according to an embodiment of the disclosure.

FIG. 9 is a more detailed view of a direct air capture system in combination with an HVAC system within a built environment according to an embodiment of the disclosure.

FIG. 10 is a depiction of direct air capture modules as well as processing circuitry in combination with a carbon capture component (Carbon Capture Utilization System, CCUS) according to an embodiment of the disclosure.

### DESCRIPTION

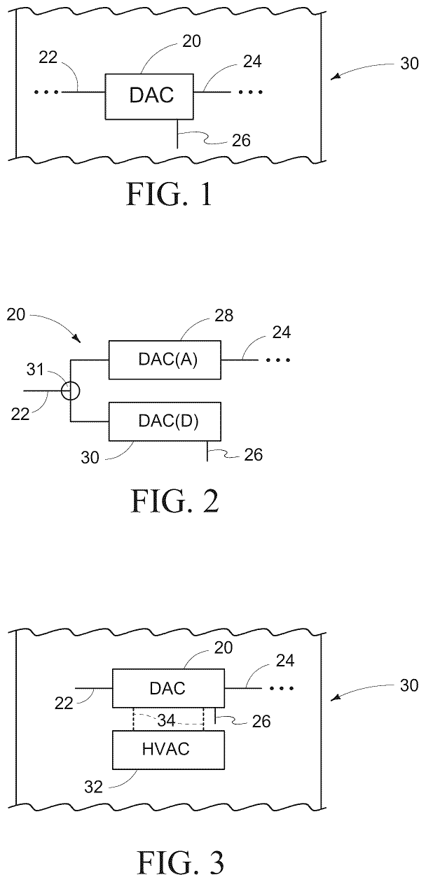

The present disclosure will be described with reference to FIGS. 1-10. Herein, built environment can include one or more of built infrastructure environments: landfills, digesters, distributed generators (turbines, internal combustion engines, fuel cells, etc.), compressors (stations), hydrogen production sites, industrial plants, buildings (industrial, commercial, municipal, schools, hospitals, residential, etc., not limited the aforementioned) and/or buildings as described in the following reference materials incorporated by reference herein. Before referring to the Figs. herein, the context of the disclosure should be viewed in combination with the following published patent applications which are hereby incorporated by reference: US 2020/0340665 by inventors William A Fuglevand, et al., entitled “Building Emission Processing and/or Sequestration Systems and Methods” published Oct. 29, 2020; WO 2022/094124A1 by inventor William A. Fuglevand entitled “CO₂ Separation Systems and Methods” published May 5, 2022; WO 2022/212719A1 by inventors William A. Fuglevand, et al., entitled “CO₂ Separation Systems and Methods” published Oct. 6, 2022; WO 2022/266377A 1 by inventor William A. Fuglevand entitled “Compositions, Systems, and Methods for Sequestering CO₂ from Combustion Flue Gas” published Dec. 22, 2022; and US 2023/0112087A1 by inventors Ken Byrd, et al., entitled “Carbon Management Systems and Methods” published Apr. 13, 2023. In combination with the above incorporated by reference materials, numbering of elements in the present application can be consistent with the numbers of the referenced materials. For example, building 30 is described in the referenced materials and referenced herein in the FIGS., as well as treatment component 10 (in this configuration to handle point source CO₂, such as combustion products), is to include combustion, separation, liquefaction, storage, and transfer, for example (e.g., Carbon Capture Utilization System, CCUS) treatment of combustion products that include CO₂ can be considered point source treatment.

Referring first to FIG. 1, an example built environment 30 is provided that includes a direct air carbon dioxide capture component 20. Direct air capture (DAC) component 20 can be coupled for intake from outside air and/or recirculating air from an HVAC system, for example. Accordingly, direct air capture component 20 can have an exhaust 24 which is coupled to an HVAC system and/or exits the built environment directly. Exhaust or stream 24 can include the composition of stream 22 having less CO₂. For example, stream 24 can include CO₂ depleted air. In accordance with example implementations, direct air capture component 20 can provide a fortified stream 26 of removed material from the direct air capture component. Stream 26 can be a mixture that is CO₂ rich, such as an air mixture that is CO₂ rich. Stream 26 can also comprise or consist essentially of CO₂, for example mostly CO₂ and trace levels of fluid that was used to desorb the CO₂ from component 20. In accordance with example implementations, intake 22 can have a carbon dioxide content and the carbon dioxide content of stream 26 can be greater than the carbon dioxide content of intake 22.

Referring next to FIG. 2, in a more detailed embodiment, the direct air capture component is presented in two modules aligned in parallel. While there are only two modules represented here, there can be multiple modules represented, with multiple modules receiving air for capture, and multiple modules desorbing captured materials. In accordance with example implementations, intake 22 can be regulated through control valve 31, and this intake can be directed towards DAC(A) module 28 for adsorption and exiting through conduit 24. In accordance with other implementations, a control valve can regulate the flow of air through DAC(D) module 30 for desorption and to exit 26.

Material within these modules can be contactor materials such as substrate materials. These materials can be configured as monoliths such as porous monoliths. The materials can define linear channels proceeding in the direction of flow to limit pressure drop between intake and exit. In accordance with example implementations, these materials can have the interior walls of the linear channels coated with amounts of adsorbents. These adsorbents can be configured to selectively adsorb carbon dioxide, for example, vs. other components and/or then desorb carbon dioxide when pressure is changed and/or the material is heated, for example. In accordance with example implementations, a series can progress where module 28 is receiving and adsorbing CO₂ while module 30 is desorbing CO₂.

The adsorbents can include but are not limited to: activated carbons, carbon molecular sieves, natural and synthetic zeolites (i.e., alkali metal aluminosilicates), aluminophosphate materials, nanoporous framework compositions such as Metal Organic Framework structures (MOF's), and Covalent Organic Framework structures (COF's) and/or mesoporous silica with self-assembled ligands. Nanoporous framework compositions can include at least two classes of materials: 1. Metal Organic Framework (MOF's) containing polynuclear metal clusters bonded to Organic linkers; and 2. Covalent Organic Frameworks (COF's) containing polynuclear non-metal clusters bonded to organic linkers. Polynuclear clusters can be referred to as secondary building units (SBU's) which impart structure and rigidity to the framework material. Nanoporous Framework compositions can be further functionalized with specialized ligands associated with the clusters and/or linkers.

Carbonaceous adsorbents are available, low cost, have high thermal stability, and low sensitivity to moisture. These materials can be enhanced to improve surface area and pore structure, include amine compound functionalization, and/or amine compound impregnation.

Zeolite adsorbents can be low cost, have high thermal stability, and can have characteristics of exchange cations. These materials can be enhanced to improve Al/Si composition ratios and/or exchange with alkali and alkaline earth cations. CO₂ has a high linear quadrupole moment which interacts with intra-zeolite cations.

Mesoporous Silica can have high surface area, high pore volume, tunable pore size, and good thermal and mechanical stability. These materials can be enhanced to provide new families such as SBA-n and ABS, altered to include amine compound loading, and/or self-assembly of amine functionalized components into larger pore structures.

Metal Organic Frameworks (MOF's) and Covalent Organic Frameworks (COF's) can have high surface areas, controllable pore structures and/or pore surface properties. These materials can be constructed to provide new types of MOF's and COF's, reduce cost of synthesis and production, and/or improve stability towards water vapor.

In addition, all materials can be evaluated for specific functionalization such as chemical attachment and/or self-assembly of amine adorned ligands, and control of aluminum to silicon ratios in synthesized zeolites.

Adsorbent materials can include: Activated Carbon (AC), Carbon Molecular Sieve (CMS), 3A Zeolite (ex. Grace 564 3A); 4A Zeolite (ex. Grace 514 4A); 5A Zeolite (ex. BASF, Grace 522 5A SYLOBEAD); 13X Zeolite (ex. Grace 544 13X, BASF 13X, Zeochem Z10-02); 13X APG (ex. UOP MOLSIV 13X APG); 13X APG III (i.e., UOP MOLSIV APG III); and Jalon JLPM3 molecular sieve; Carbon NanoTubes (CNT); Graphene Supported Materials; LiLSX Zeolite (Lithium exchanged forms of LSX Zeolite, i.e., VSA-10); other cation exchanged materials; and nanoprous framework composition materials.

Additionally, one or more of these adsorbent materials can be performance enhanced. Particular materials, including enhanced materials, can lower the pressure or temperature required for PSA and TSA assemblies thus providing a system that requires less energy to operate. For example, mesoporous silica can be enhanced to include self-assembled functionalized amine ligands. Accordingly, synthetic porous materials can be modified for enhanced CO₂ working capacity and selectivity through one or more of the following changes:
a. Modification of the SI/AL ratio in zeolite structures.
b. Selection of various metal cations in Zeolites.
c. Impregnation of Amine compounds within pores and cages.
d. Chemical attachment of amine ligands to surface features.
e. Self-assembly of amine ligands within pores (mesoporous silica).
Now referring to FIG. 3, DAC 20 can be operatively integrated with an HVAC system 32 via conduit lines 34. In accordance with example implementations, the integration can include receiving intake air to 20 via the recycling air of the HVAC system and returning same through the HVAC system. In this implementation, exit 24 may not exit the building or may exit the building in combination with the return of carbon dioxide reduced air to the HVAC system 32. The HVAC system can be any traditional HVAC system utilized in residential to industrial buildings.

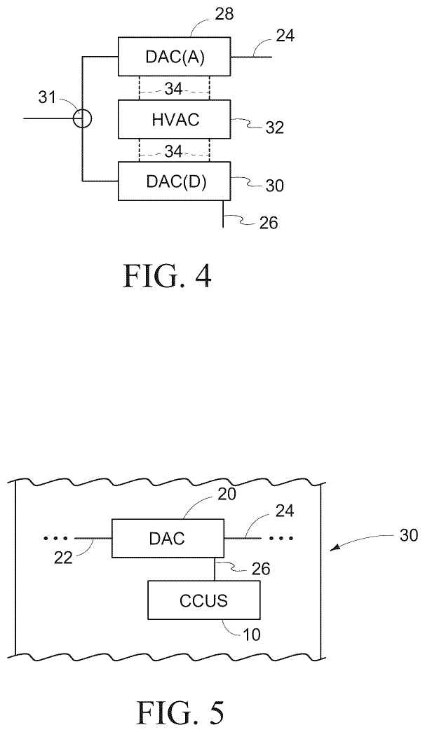

Referring next to FIG. 4, a more detailed integration of DAC modules 28 and 30 is shown with the HVAC system configured to engage separately module 28 from module 30. In accordance with example implementations, during adsorption, the HVAC system may be configured to provide cooler air to DAC module 28, thereby facilitating adsorption of CO₂ on the selected material within module 28, and during desorption, the HVAC system may be configured to provide warmer air to DAC module 30, thereby facilitating desorption of CO₂ from the material within module 30.

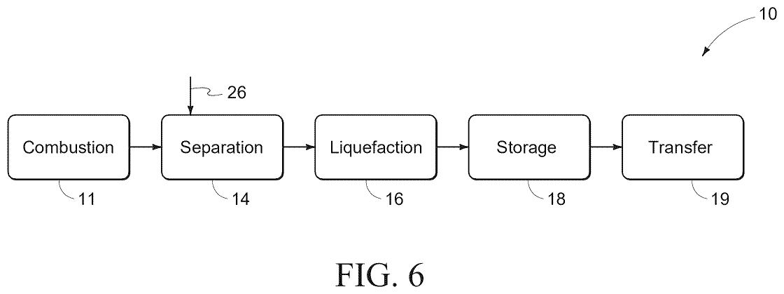

Referring next to FIG. 5, as shown within building 30, DAC module 20 can be integrated with a point source separation system 10. This separation system is well described in the referenced materials as well as the management and operation of same. More particularly, with reference to FIG. 6, stream 26 can be operatively coupled to separation component 14 of a complete or partial system 10.

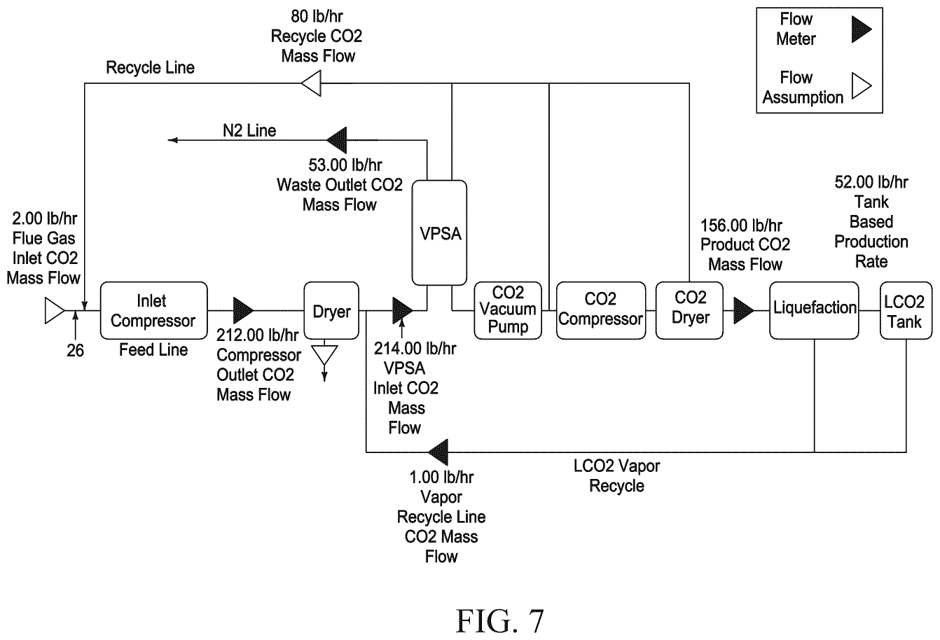

Referring next to FIG. 7, a more detailed example shows stream 26 operatively coupled prior to the inlet compressor as shown in FIG. 7. In FIG. 7, an example CO₂ separation and/or capture flow is shown that includes sensors configured to determine flow and amount of CO₂ at locations in the process. As shown, there are flow meters and flow assumptions.

In accordance with at least one example implementation, a carbon capture system can include an inlet compressor configured to receive flue gas from a combustion source within a built environment (in one example, a building). The combustion source within the built environment can be a natural gas combustion source within a residential building for example.

This inlet compressor can be operatively coupled to a VPSA assembly. The VPSA assembly can be operatively coupled to a liquefaction assembly configured to provide liquid CO₂, for example. The system can include a plurality of flow/sensor assemblies operatively engaged between the inlet compressor and the VPSA, and the VPSA and the liquefaction assembly. The system can also include processing circuitry configured to receive rate data from the plurality of flow/sensor assemblies and process the data to determine one or more system performance parameters. The system performance parameters include system recovery percent, and/or the processing circuitry can be configured to use the CO₂ rate data to determine one or more system performance parameters.

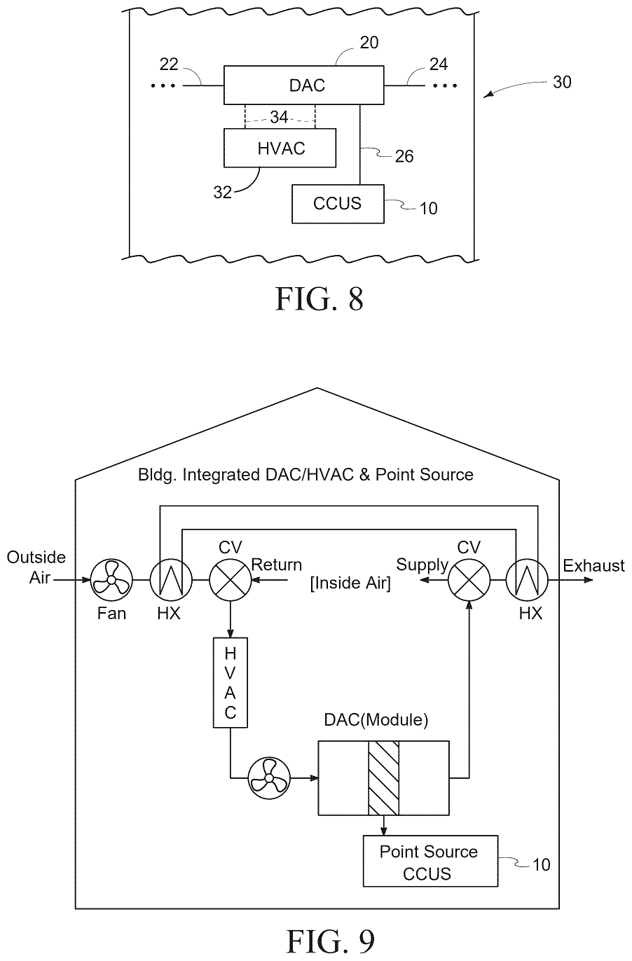

Referring next to FIG. 8, as shown in built environment 30, both DAC module 20, HVAC system 32, and carbon capture system 10 can be integrated with built environment 30 and utilized accordingly. In accordance with example implementations and with reference to FIG. 9, a more detailed view of this integration is shown. As shown, ambient air can enter and undergo heat exchange, and then via control valve provided to a DAC module. The DAC module can be integrated with an HVAC system and upon exiting the DAC module, a control valve can return the air to supply air to rooms and/or the control valve can be configured to exit the air from the built environment. In accordance with example implementations, the air exiting the built environment and the air entering the built environment can be controlled via a coupled heat exchange. In accordance with example implementations, the CO₂ volatiles that exit the DAC module can be provided to the carbon capture system as described herein.

Direct Air Capture (DAC) coupled with building heating, air conditioning and ventilation (HVAC) is designed to remove CO₂ from incoming air, recirculated air and building exhaust. Furthermore, DAC is synergistically integrated with the point source building CCUS system which receives DAC output to proceed through existing CO₂ purification, liquefaction, and storage functions. The CCUS system can also assist in removing residual water vapor or other volatiles in the DAC output. In total, the integrated building DAC and CCUS system exceeds building emission reduction standards while providing high quality internal air in support of human activities.

In practice the DAC module can be free standing or incorporated within the HVAC system equipment. The DAC output will feed forward to the point source CCUS system which will further purify captured CO₂ resulting in a commercial grade liquid CO₂ product ready for off-take.

The DAC module incorporates large surface area contactors or channeled air flow directors designed to promote high air flow with low pressure drop. Contactor surfaces are coated with CO₂ selective solid adsorbents such as MOFs, COFs, zeolites, silica, or other functionalized porous material. The DAC module is compartmentalized to support concurrent sorption and desorption of CO₂ using separation processes such as PSA, VSA, TSA, ESA, etc.

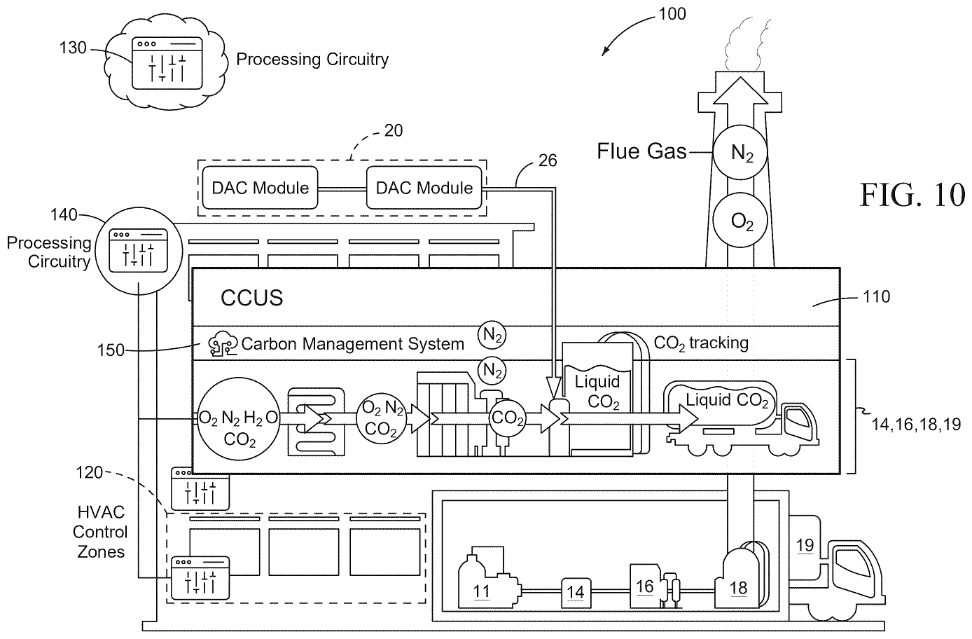

FIG. 10 is a depiction of system 100 that includes DAC components 20 associated with a building and operatively coupled to both mechanical components: CCUS 110 having components 14, 16, 18, and 19, as well as HVAC system 120. System 100 can also include processing circuitry components 130, 140, and 150 to optimize, control, and/or manage carbon capture of carbon dioxide within and outside the building.

The systems and methods of the present disclosure can be configured to either or both remove CO₂ and/or avoid CO₂ emissions. For example, DAC assemblies can be configured to remove CO₂ from the air about the built environment and/or CCUS can be configured to avoid CO₂ emissions. Accordingly, the systems and methods can be configured, and processing circuitry operated to track and account for both removed CO₂ and CO₂ emissions avoided. In accordance with example implementations, the use of these systems and methods can make the built environment carbon neutral or even carbon negative from an emissions perspective. In at least one configuration, a DAC assembly can be configured to receive and remove CO₂ associated with the built environment then provide a CO₂ concentrated stream to a CCUS where it is processed further and/or liquefied with CO₂ captured from a combustion source of the built environment. The processing circuitry can also be configured to track energy associated with each process and provide both gross CO₂ molecule captured and net CO₂ after accounting for carbon emissions from the process.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

1. A carbon capture system operatively associated with a built environment, the system comprising a direct air carbon dioxide capture component operatively engaged with a mechanical component of the built environment.

2. The system of claim 1 wherein the direct air carbon dioxide capture component comprises one or more direct air capture modules.

3. The system of claim 2 wherein the air handling component is operatively engaged with at least two operatively aligned direct air capture modules.

4. The system of claim 1 wherein the mechanical component comprises an air handling system of the built environment.

5. The system of claim 3 wherein the air handling system comprises an HVAC system and the direct air carbon dioxide capture component is configured to receive intake from the HVAC system.

6. The system of claim 3 wherein the air handling system comprises an HVAC system and the direct air carbon dioxide capture component is configured to provide carbon dioxide reduced air to the HVAC system.

7. The system of claim 1 further comprising a carbon capture system operatively engaged with a combustion source of the built environment, wherein the direct air carbon dioxide capture component is operatively engaged with the carbon capture system.

8. A carbon capture system operatively associated with a built environment, the system comprising a direct air carbon dioxide capture component operatively engaged with a carbon capture system of the built environment.

9. The system of claim 8 wherein the carbon capture system comprises one or both of a separation component and/or a liquefaction component, wherein the direct air carbon dioxide capture component is operatively engaged with either of the separation component or the liquefaction component.

10. The system of claim 9 wherein the direct air carbon dioxide capture component is operatively engaged with the liquefaction component.

11. The system of claim 9 wherein the direct air carbon dioxide capture component is operatively engaged with the separation component.

12. The system of claim 11 wherein the separation component comprises a VPSA that is operatively engaged with a liquefaction component.

13. The system of claim 8 further comprising processing circuitry operatively configured to manage, control, and/or optimize the building carbon capture system, the direct air carbon dioxide capture component, and/or the combustion carbon capture system.

14. The system of claim 13 wherein the processing circuitry is operatively engaged with air handling controls of the built environment.

15. A method for capturing carbon dioxide associated with a built environment, the method comprising engaging a direct air carbon dioxide capture component with a mechanical component of the built environment, and while engaged producing both a stream of reduced carbon dioxide air and a stream of carbon dioxide.

16. The method of claim 15 wherein the mechanical component comprises an HVAC system, the method further comprising engaging the direct air carbon dioxide capture component with the HVAC system of the built environment.

17. The method of claim 16 further comprising providing cooled air to the direct air carbon dioxide component using the HVAC system to capture carbon dioxide with the direct air carbon dioxide component to form the stream of reduced carbon dioxide air.

18. The method of claim 17 further comprising providing heated air to the direct air carbon dioxide component using the HVAC system to desorb captured carbon dioxide from the direct air carbon dioxide component to form a stream comprising carbon dioxide.

19. The method of claim 15 wherein the mechanical component is a carbon capture unit.

20. The method of claim 19 further comprising providing the stream of carbon dioxide to one or both of a separation component and/or a liquefaction component of the carbon capture unit.
